(19) United States
(12) Patent Application Publication
(10) Pub. No.: US 2003/0210654 A1
(43) Pub. Date: Nov. 13, 2003

(54) Method of parallel packet switching

(75) Inventors: Aleksey V. Son, Seoul (KR); Vladimir M. Son, Seoul (KR); Myung Sik Son, Seoul (KR); Hyung Moo Park, Seoul (KR); Jin Koo Rhee, Seoul (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: Dongguk University

(21) Appl. No.: 10/141,640

(22) Filed: May 7, 2002

(51) Int. Cl. H04J 1/16

(52) U.S. Cl. 370/238; 370/252

(57) ABSTRACT

Present invention relates to telecommunication switching systems and methods of packet switching and can be usable at development new high-speed telecommunication devices and equipment as switching structure.

Iterative network structure, according to invention, is described using associative switching theory. Network nodes are disposed in associative arithmetical space. Inter-nodal relations are preset by binary relations of associative theory and have properties of reflexivity, symmetry and transitivity. Each node is represented by single radius neighborhood. Inter-nodal one-to-one connectivity of inputs and outputs of couple of transmitting and receiving nodes is defined by system of substitutions. Parallel routing algorithm is realized as permutation operation on a set of substitutions in-group of single radius neighborhoods.

The information-processing rate is sped up due to concurrency of node processing operations up to multiplying by N²² in associative network with N nodes.

The offered method is intended for increasing of switching speed and for reaching high and ultra-high rates of processing and distribution of information.

### FIELD OF THE INVENTION

The present invention relates to methods of parallel data processing, switching and distribution in telecommunication switching systems and can be usable at development new broadband high-speed telecommunication systems and devices.

### BACKGROUND OF THE INVENTION

The modern telecommunication systems should support high-speed transmission of various data types. To take advantages of the high-speed transmission and high-speed channels, switching devices should provide minimum time of making routing decision and processing capabilities of dynamically varying traffic. Existing systems are based on n-relations of the graph G=(M, L), L⊂Mⁿⁿ, n>2, as bipartite graphs. These systems perform sequential data processing. The general packet-switching techniques cannot be applied for high-speed networks. New modes and methods of information processing, switching and distribution are required. The offered method is intended for increasing of switching speed and for reaching high and ultra-high rates of processing and distribution of information.

### SUMMARY OF THE INVENTION

The present invention proposes the method of parallel processing, switching and distribution of information of high-speed packet switching systems. The method is based on a mathematical apparatus of the associative theory and algebra of groups. The offered method of parallel packet switching covers new conceptual framework of switching systems, self-routing algorithm and parallel switching. Switching structure is described, as associative switching system and switching procedures are parallel executed as operations of multiplicative group.

### BRIEF DESCRIPTION OF THE DRAWINGS

FIG. 1 shows the base structure of associative network,

FIG. 2a shows switching function T,

FIG. 2b and FIG. 2c show properties of associativity and transitivity of function T,

FIG. 2d shows property of symmetry (or property of inverse element),

FIG. 2e shows property of reflexivity (or property of unit element),

FIG. 3 shows the set-factor of associative switching structure,

FIG. 4 shows scheme of finite state automaton of node input,

FIG. 5 shows the substitution system of associative switching structure.

### DETAILED DESCRIPTION OF THE INVENTION

Detailed description of offered method will be represented with accompanying drawings.

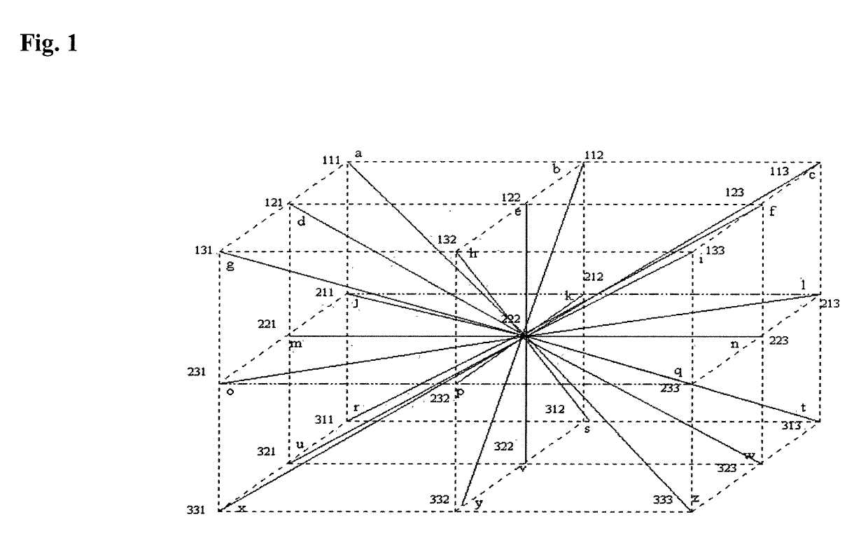

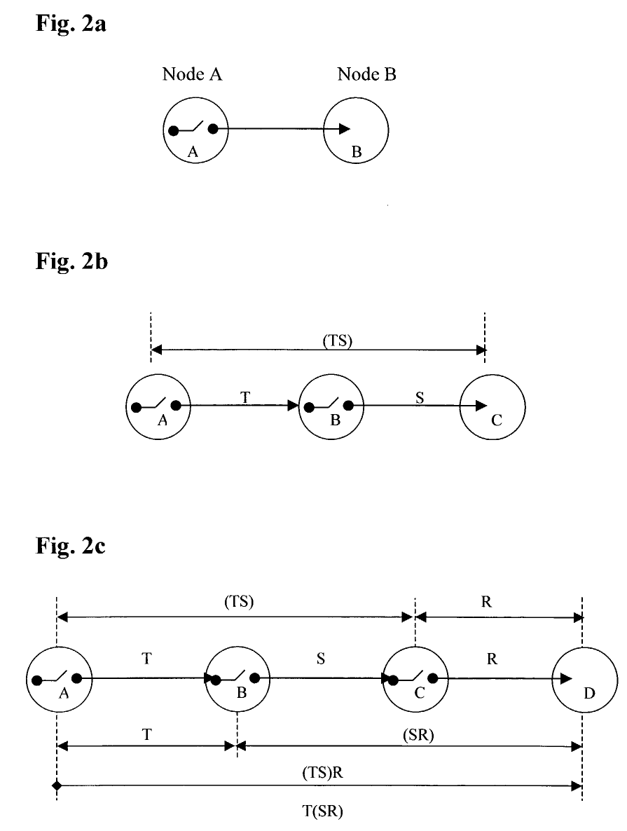

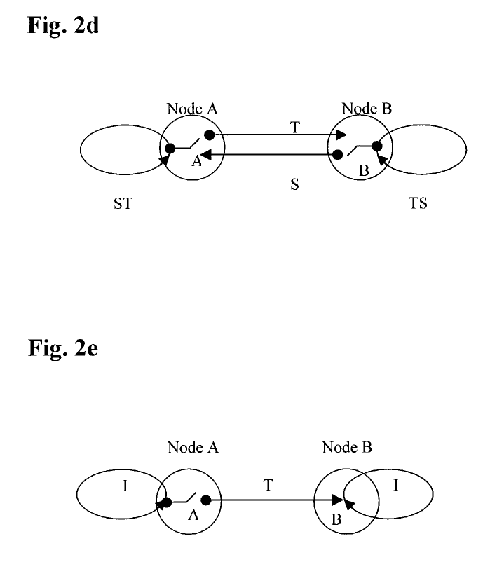

Present invention considers the grouping of switching system. System is described as scheme of nodes with binary relations in the graph G=(M, L), L⊂M². Initially, arithmetic space with base coordinates i, i∈(1, 2, . . . , k), alphabet A={1, 2, . . . , a} and system F of conversion, F={1-1, 1-2, 2-2, 2-3, etc} should be assigned. The specified switching system will be set up as associative iterative and k-dimensional system. The number k of coordinates determines the dimension of associative space of switching structure: at k=2, it is the 2-D iterative network; at k=3 it is the 3-D iterative network, etc. Network nodes are represented by words of associative calculus and marked as a-bit words, according to number of coordinates. The relations of words are defined by system F. The total N number of network nodes is equal N=a^{k}. FIG. 1 shows the iterative network at parameters: k=3, a=3, N=27. This is base structure of network extension. The word of set N can be transformed to another word of set N. If the word R∈N can be transformed to word S∈N by means of single application of permissible conversion of F, then the word S also can be transformed into word R by the same way. Let R=111, S=112, the words “111” and “112” will be converted as R->S and S->R by means of conversion 1-1, 1-2 of system F. In this case, words R and S are adjacent words, and the network nodes, which are mapping by these words, are adjacent ones. If there is the sequence of pair wise adjacent words R₁, R₂ . . . Rₖ (R->R₂; R₂->R₃; . . . , Rₖ₋₁->Rₖ, then this sequence is the deductive chain from node R₁ to node Rₖ. Apparently, there is an oppositely directed deductive chain from node Rₖ to node R₁. In this case, words become equivalent ones, and they are marked as R₁∞Rₖ. If the iterative network has properties of transitivity and associability S∞R and R∞T, then S∞T, (S∞R)*(R∞T)=(S∞T) and (S∞R)=(R∞T)*(S∞T) are valid. The iterative network with binary relations is the iterative associative network. The number of connecting lines of one node is equal to (N-1) number of adjacent nodes. Thus, the deductive chain from any of Sᵢ-node to Sj-node; Sᵢ, Sⱼ∈N, represents inter-nodal network path. The equivalence of words corresponds to mutual accessibility of each couple of nodes. The switching procedure is implemented in the nodes and relatively each node information transformation will create its own “network configuration”. As it is shown in FIG. 2a, the switching function T transfers the information from node A to uniquely defined node B, B=T (A), where node A is argument A, and function T is function of switching. The associative iterative network is characterized by the next properties. FIG. 2b and FIG. 2c show properties of associativity and transitivity. Property of symmetry (or property of inverse element) is shown in FIG. 2d. Property of reflexivity (or property of unit element) is shown in FIG. 2e.

| | |
|---|---|
| Association and transitivity: | TSR = (TS) R=T (SR) |
| Symmetry (property of inverse element): | function T − S and ST − |
| | TS are symmetric ones |
| Reflexivity (property of unit element): | IA=A, B=B (I), IT=TI |

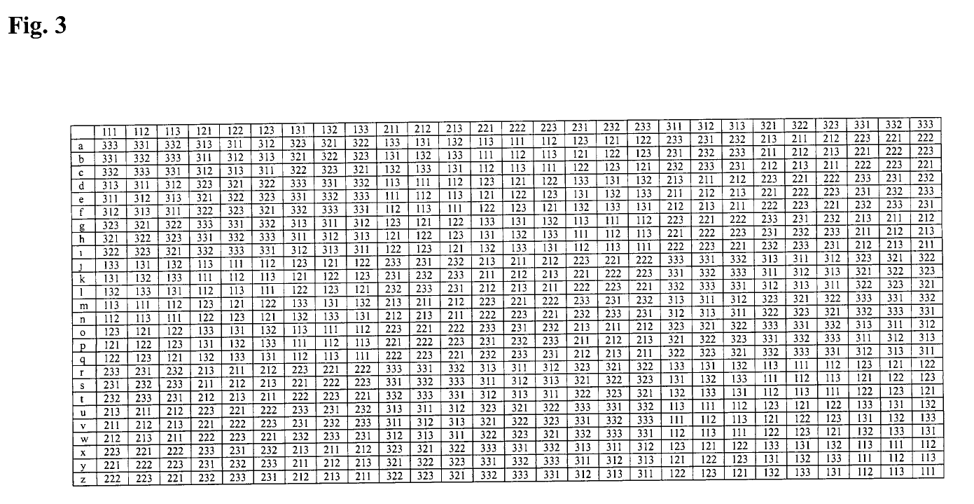

In an associative iterative network, the word conversion requires the digit-by-digit analysis of words for definition of a full set of deductive chains. This operation can be hard warily realized with the finite state automaton or microprocessor-based hardware. Inter-nodal binary relations designate the set-factor of structure. FIG. 3 shows set-factor of associative switching structure. Set-factor of node describes all connected nodes in numerical order of its outputs and a node set-factor is represented as table's column. Binary relations also can be described relatively to reciprocity relation of node inputs/outputs and connecting lines. Single radius neighborhood (SRN) of node describes one-to-one mapping of current node outputs and lines. Any connecting line is bi-directional one and it connects 2 contiguous nodes. Therefore, input/output line numbers are equal to corresponding numbers of node inputs/outputs and SRN describes ordinal number of connecting lines of current node:

SRNᵢₗ={aᵢᵢ, bᵢᵢ, cᵢᵢ, . . . , zₗₗ, Sₗₗ}, i-node number, i∈N.

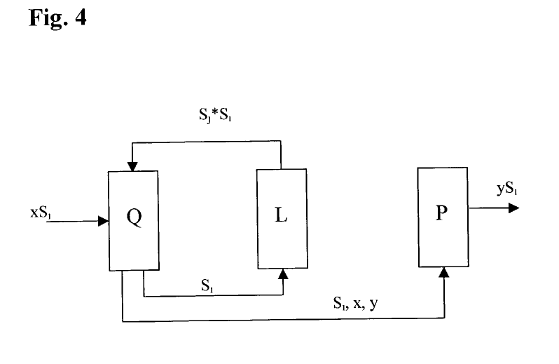

Here, range of definition of node set and single radius neighborhood of each node are equal among themselves. Each node has additional input/output line S for incoming and outgoing traffics. There are two types of data flows. Information data enters and goes out of node through line S and connecting lines {a, b, c, . . . , z} of adjacent nodes. During processing of received packet the address of a receiving node is extracted from the packet's header. If the address of a receiving node coincides with the address of current node, the packet is sent through line S. Otherwise, packet routing decision is carried out and packet will be transferred to another node or it will be buffered. The offered method of parallel packet switching provides the following algorithm of routing. The base structure consists of 27 nodes. Each node is connected to all adjacent nodes by 26 connecting lines. Each couple of nodes has corresponding substitution of SRN from units a, b, c . . . z., which is connecting links. Thus, described structure is the associative iterative switching structure with inter-nodal and exterior lines linking nodes among themselves and information destination ports. The node can be imaged as 3-D uniformly structured “processor”, which implements specialized functions of processing, switching and distribution of information. Each node input is functionally implemented by the scheme of finite state automaton. The total number of internal states of finite state automaton is equal N. The transition from one state in another occurs as result of effect of a pair of signals of (SRN) and Sᵢ on an internal condition Sⱼ of the automaton. Then, the automaton produces signal Sᵢ (SRN) on one of the outputs, for example, xSᵢ->ySₗ, where x, y∈(SRN). In this case automaton function is defined by four elements (x, y, Sᵢ, Sⱼ) and is implemented by the operator Q: y=Q (x, Sᵢ, Sⱼ). Operator Q is determined by multiplicative group of substitution xSₗ->Sₗ*Sⱼ->ySⱼ, where *- sign of substitution operation of values (SRN) on itself. FIG. 4 shows the scheme of the automaton for a node input, where L, Q, P—logical, operational, control sub-units, accordingly. All node automatons operate parallel and independently and so, the system data processing rate is sped up. The block Q implements steps of algorithm, P-execution of switching and information transfer. The logical block L realizes the function xSᵢ->ySₗ of conversion each pair of signals xSₗ in a signal ySₗ. Total number of such pairs of signals is defined by number of node inputs/outputs and equal N².

$$Substitution of i - node ( \begin{matrix}{a}_{ii} , {b}_{ii} , {c}_{cii} , … , {z}_{i } \\ {a}_{ji} , {b}_{j} , {c}_{cji} , … , {z}_{j}\end{matrix} ) \begin{matrix}defines inter - nodal connection of inputs / outputs \\ of i - transmitting and j - receiving nodes .\end{matrix}$$

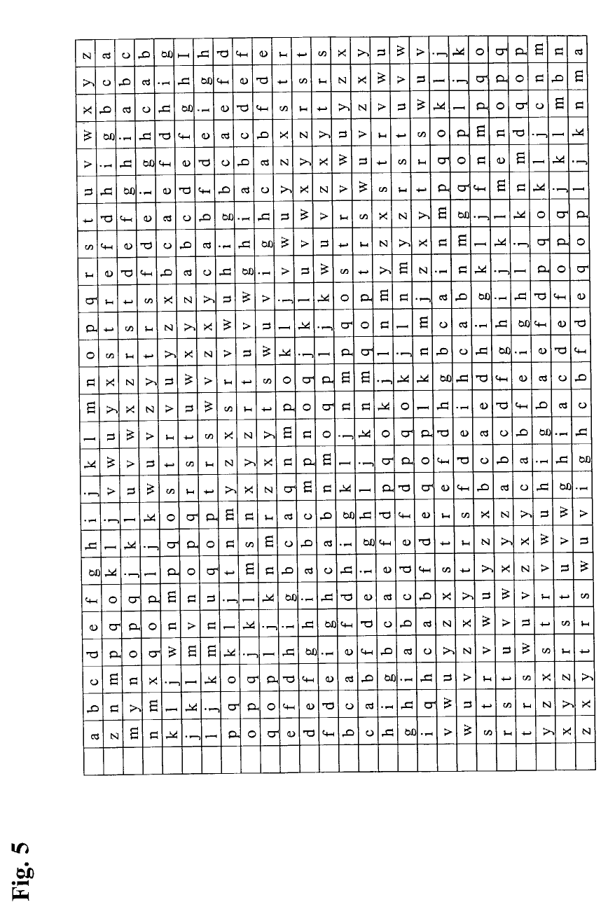

This substitution is unique one for couple of nodes. FIG. 5 shows the substitution system of structure. The first column is empty. For definition of substitution system of transmitting node, the corresponding column of set-factor table should be selected and placed instead of the first column of substitution system table. Then, the one-to-one connectivity of inputs and outputs of transmitting and receiving nodes is defined by two rows of system of substitutions. First row is the first row of substitution table, because it appropriates to transmitting node and second row is the row, corresponding to receiving node. Any substitution of transmitting and receiving nodes is divided into cycles of deductive chains. For each couple of nodes there are 9 cycles of total 26 paths. The routing and switching can be done using one of 26 paths:

Through direct connecting line: <<node >>-<<line>>-<<node>>.

Through one of 25 routes path: <<node>>-<<1^{stst} line>>-<<intermediate node>>-<<2^{ndnd} line>>-<<node>>.

Deductive chains are independent chains. That is why path-searching procedures can be parallel executed. If the states of input and output lines of adjacent nodes are known, parallel switching procedures can be performed. Let's designate by X the result of multiplication operation ∫:

X=Kₗₘₙ∫Kₛₜ(lmn),

where

Kₗₘₙ—substitution of lmn-receiving node,

∫—multiplication sign of permutation in substitution of receiving node,

Kₛₜₛₜ(lmn)—state of input lines of lmn-receiving node.

Let matrix I is column matrix as result of matrix logical product of X and Kₛₒₛₒ (ijk)

I=X(\hat{ })Kₛₒₛₒ(ijk)

where:

(\hat{ })—sign of matrix logical multiplying,

Kₛₒₛₒ(ijk)—state of output lines of ijk-transmitting node.

Matrix I consists of “1” and “0” signs, which display in numerical order the idle and busy states of deductive chains through output lines of a transmitting node. Selection of an idle chain can be realized through selection of first of several unities in single-column matrix I. The matrix I should be modified to one-column matrix W, containing only one “1”sign, defining serial number the first idle and accessible path, i.e. that output of transmitting node, through which it is possible to set-up connection between transmitting and receiving nodes. Let matrix P is a triangular unitary matrix of dimension 26×26. Matrix W, as product of logical matrix multiplying, is obtained:

W=|P(\hat{ })I|\hat{ }A

If matrix W doesn't include a “1” sign, it means that, at the present situation, there are no accessible path, and processed packet should be buffered. Parallel processors can realize these procedures of matrix calculation.

The parallel switching algorithm is described as:

Algorithm: Parallel switching algorithm (PSA)

| | |
|---|---|
| 1. | PSA(packet) |
| 2. | { |
| 3. | select addresses (ijk) and (lmn) |
| 4. | if(lmn==ijk) |
| 5. | send packet to line S |
| 6. | stop |
| 7. | end /* if */ |
| 8. | if(lmn != ijk) |
| 9. | assign address ijk |
| 10. | check states Kₛₒ (ijk) and Kₛₜ (lmn) |
| 11. | select SRNᵢⱼₖ and SRNₗₘₙ |
| 12. | Execute permutation operation in Kₛₒ according SRNₗₘₙ : X = Kₗₘₙ ∫ Kₛₜ(lmn) |
| 13. | Execute I = X (\hat{ }) Kₛₒ(ijk) |
| | — |
| 14. | Execute W = \| P (\hat{ }) I \| \hat{ } I |
| 15. | for I:= 1 to k |
| 17. | setup path through i-output. |
| 18. | stop |
| 19. | end /* if */ |
| 20. | buffer packet |
| 21. | end /* if */ |
| 22. | } |

The multiple paths between nodes complicate communication protocols. Existing routing protocols are based on processing of packet header and address TAG ⊕ of transmitter and receiver nodes and procedures of paths selection on the basis of the tables, cost optimization functions or self-routing. The offered method belongs to the class of self-routing algorithms. During processing of packet header, all paths between transmitter and receiver nodes and their states/accessibility have being simultaneously checked. Parallel execution of switching is based on: 1) analysis of states and selection of independent deductive chains of different pairs of network nodes; 2) parallel function of node input automatons. The system data processing is sped up to N²² time, according to number of node and parallel processing blocks of each node.

Scope of invention is limited only by the attached claims.

What is claimed is:

1. Method of parallel packet switching, based on application of associative switching theory for description and construction of network structure and data processing, where network structure is represented as associative arithmetical space; network nodes are represented by words of associative calculus; inter-nodal connections are described as binary relations in the bipartite graph with properties of reflexivity, symmetry and transitivity; routes correspond to deductive chains of word conversion; switching function is described as multiplicative group, said method comprising the steps of: mapping of adjacent nodes relatively numerical order of current node outputs on basis of set-factor; mapping of node outputs relatively inputs of all adjacent nodes according to node's single radius neighborhood; definition of substitution system of the receiving node; permutation operation of elements of receiving node substitution system, relatively to single radius neighborhood of receiving node, and transferring a packet through selected inter-nodal line.
